(19) United States
(12) Patent Application Publication
(10) Pub. No.: US 2026/0359866 A1
(43) Pub. Date: Nov. 12, 2026

(54) Adaptive AI-Native Creative Personalization Layer for Contextual Advertisement Rewriting

(71) Applicant: Roee Rahamim, Hertzliya (IL)

(72) Inventor: Roee Rahamim, Hertzliya (IL)

(21) Appl. No.: 19/203,050

(22) Filed: May 8, 2025

(51) Int. Cl. G06Q 30/0251; G06Q 30/0601

(52) U.S. Cl. CPC G06Q 30/0269; G06Q 30/0631

(57) ABSTRACT

The present disclosure describes a system and method for AI-driven rewriting of advertisement content through a user-linked personal agent. The agent continuously monitors diverse user context data—such as calendar events, location, biometric signals, and sentiment—to dynamically generate personalized recommendations. Upon explicit or inferred triggers, the agent retrieves third-party offers and applies sentiment-aware natural language processing and style-transfer to adjust tone, graphics, and audio. Tailored ads are delivered across modalities, and impressions, interactions, and conversions are tracked for real-time commission attribution, enabling proactive, contextually optimized advertising experiences.

### BACKGROUND OF THE INVENTION

In the prior art, advertisement personalization is typically performed by static user-profile systems that rely on pre-segmented demographic data and batch-processed A/B testing. For example, systems such as Smith et al. (U.S. Pat. No. 10,123,456) and Doe et al. (WO 2018/012345) generate personalized email or banner campaigns based solely on past purchases or declared interests, without real-time contextual adaptation or emotional modeling.

Other platforms, such as Google AdWords and Facebook Ads, dynamically select ad variants based on click-through statistics, but do not integrate biometric or sentiment signals, nor do they perform on-the-fly style transfer of text, graphics, or audio. As a result, these approaches cannot tailor multimodal content to the user's current mood or immediate context.

Moreover, existing solutions typically monetize only at the conversion stage, lacking a unified pipeline that tracks impressions, clicks, and conversions in a seamless manner for real-time commission attribution.

AI personal agent means any software or service implementing an intelligent virtual assistant that interacts with users via natural language or graphical interfaces. Examples include voice-based assistants (e.g., Siri, Alexa, Google Assistant), conversational chatbots (e.g., ChatGPT, Claude), or embedded avatars and virtual personas.

Creative Personalization Layer means the AI-driven module responsible for rewriting and adapting advertisement content to match user profiles, emotional preferences, and contextual triggers.

Exposure Commission means a fee charged each time the agent presents a personalized recommendation (impression).

Click/Interaction Commission means a fee charged when the user actively engages with the recommendation (e.g., clicks or requests details).

Conversion Commission means a fee charged upon successful completion of a transaction initiated by the agent's recommendation (e.g., booking or subscription).

### SUMMARY OF THE INVENTION

The present invention leverages user-linked AI personal agents—regardless of modality or vendor (e.g., Siri, Alexa, Google Assistant, ChatGPT, Claude, custom avatars, or future robotic embodiments)—to dynamically transform and deliver content-driven recommendations and advertisements. These agents become the user's closest companion, learning deeply about personal history, preferences, and emotional patterns to engage in natural, ongoing conversations—via text, voice, video avatars, or even face-to-face interactions in robotic form. Acting as a holistic life partner, the agent blends this personal insight with contextual triggers to seamlessly offer the most relevant suggestions as part of everyday dialogue, much like a trusted friend or human assistant.

The system proactively anticipates user needs by continuously analyzing context and emotional signals—rather than merely reacting to explicit commands—enabling the agent to surface relevant recommendations (e.g., offers, bookings, reminders) without a direct user request.

### BRIEF DESCRIPTION OF DRAWINGS

FIG. 1 is a flowchart illustrating the sequence of operations performed by the Creative Personalization Pipeline, including Context Gathering, Parsing & Metadata Extraction, Sentiment-Aware NLP/Style Transfer, Graphical & Multimedia Adaptation, Presentation Module, and Monetization Logging with attribution events (Impression, Click, Conversion).

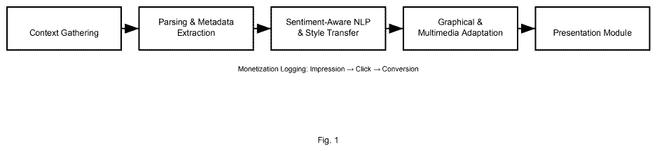

FIG. 2 is an example side-by-side depiction of a Generic Ad versus a Rewritten Personalized Ad, showing modifications in text style, iconography, and graphic layout to reflect user context and preferences.

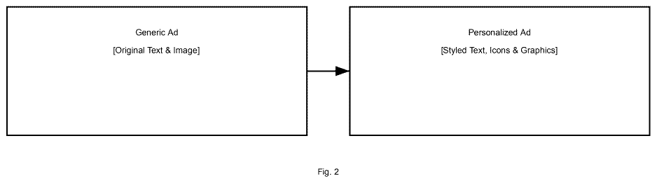

FIG. 3 is a schematic diagram of the Emotional Signal Integration and Style-Transfer Module. It shows: An Emotional Signals input (e.g., EEG, biometric sensors, sentiment analysis) feeding into a Signal Analyzer component. The analyzer output flowing into a Style-Transfer engine, which adapts text, graphics and audio tone (pitch, cadence) based on the user's affective state. The module then links to the NLP Core and Graphics Core to produce fully styled ad content. This captures the full pipeline from raw emotional sensing through multimodal content adaptation.

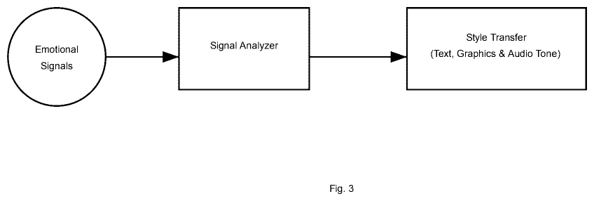

FIG. 4 is a block diagram of the Voice Modeling and Synthesis Layer, illustrating the Voice Profile Database, Voice Analysis component (pitch, cadence extraction), a Synthesis Engine, and optional Lip-Sync synchronization for avatar-based delivery.

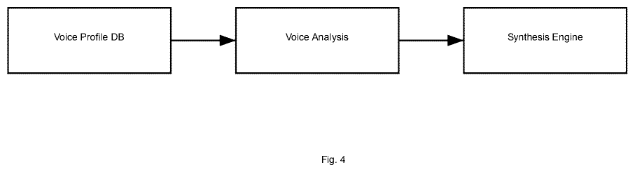

FIG. 5 is a feedback loop diagram showing User Feedback (click metrics, view time, reactions) feeding into an Analytics & Learning Module, which updates the style-transfer and presentation models in an iterative loop.

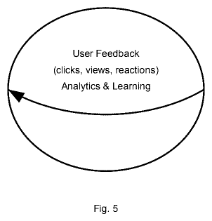

FIG. 6 is a decision flow diagram for Affiliate Switching, highlighting a User Preference decision node (e.g., Airbnb vs. Hilton), branches to switch affiliate partners, update commission rates, and resume personalization processing.

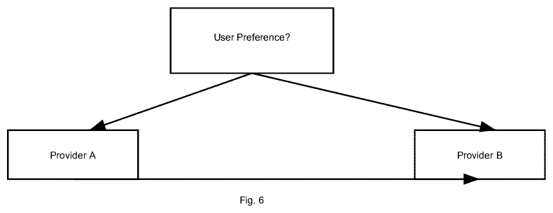

FIG. 7 is an architectural diagram of the Privacy-Preserving Analytics Module, showing layered encrypted data ingestion, a secure enclave or homomorphic computation engine, and an internal analytics and logging subsystem, with data flow arrows indicating encrypted-to-secure processing within sandbox constraints.

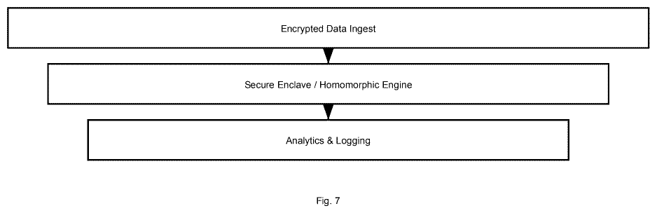

FIG. 8 is a high-level flowchart illustrating the end-to-end system flow from the user's trigger event (e.g., calendar notification or voice command) through Context Gathering & Parsing, Style-Transfer & Adaptation, Presentation Module (UI or TTS), User Interaction (click or consent), Execution (API call to the external service), and Monetization Logging of impressions, interactions, and conversions.

FIG. 9 is a swim-lane sequence diagram illustrating message exchanges between the User, Personal AI Agent, External Service Provider (e.g., Hotel API), Payment Gateway, and Analytics Module. It shows steps including the user's booking request, context lookup, personalized suggestion generation, user confirmation, external API booking call, confirmation receipt, user notification, and logging of the conversion event.

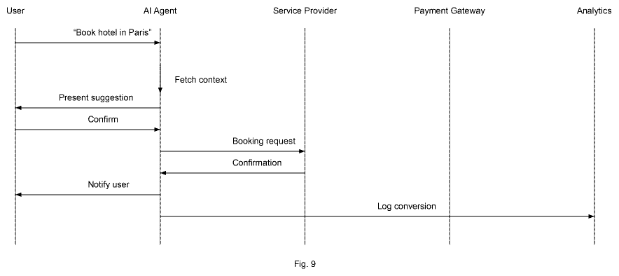

FIG. 10 is an example user-interface mock-up illustrating the actual presentation of a personalized advertisement. It shows the rewritten headline and subtext at the top, an emotional/status indicator (mood icon 100), a main image placeholder (200), a “Book Now” control button (300), and real-time feedback elements such as a loading spinner (400).

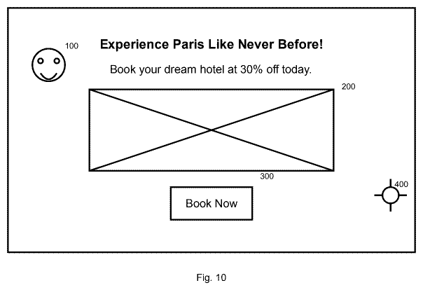

### DETAILED DESCRIPTION OF THE INVENTION

The embodiments described herein are illustrative and non-limiting. The claimed invention is defined solely by the appended claims and encompasses any modifications or equivalents falling within the scope thereof.

The present invention relates to a system and method for dynamic, AI-driven transformation of advertisement content through any AI personal agent. The agent continuously monitors a comprehensive set of user context data, including, but not limited to, calendar events and schedules, geolocation and travel plans, shopping lists and to-do lists, health metrics and medical recommendations, personal preferences and historical choices, device activity logs (phone, vehicle telematics, IoT sensors), social media activity, email and messaging content, browser history, biometric signals, physiological signals, voice interaction transcripts, and emotional and sentiment signals extracted from past interactions—including current emotional state inferred from recent events (e.g., relationship changes, mood shifts) and, optionally, other affective or cognitive indicators as may be determined by future data sources.

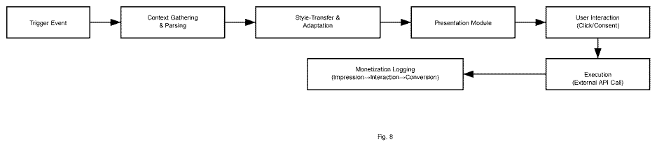

Upon receiving or inferring a trigger (e.g., user command to book accommodations, scheduled events, or shopping needs), the agent retrieves third-party offers matching the combined context data and then executes a personalized rewriting process by parsing the original ad copy or offer metadata; applying sentiment-aware NLP or neural style-transfer to adjust tone, language, and emotional framing; adapting graphical and multimedia elements such as audio narration, video sequences, AR overlays, VR environments, and holographic displays; and presenting the rewritten recommendation through the user's preferred modality. FIG. 8 illustrates this system flow end-to-end, from context gathering to monetization attribution. The system logs each interaction event—impression, click/interaction, and conversion—for commission tracking.

### Embodiments and Examples

Example 1: During a health consultation, the AI personal agent reads the user's blood test results and doctor's recommendation to exercise. Mid-conversation, the agent alerts: “I see your physician recommends regular workouts; would you like a membership at the Holmes Place gym nearby? They're running a 50% off new member special. Should I check availability for you?” Upon confirmation, the agent secures the trial membership, generating a hot lead and earning an exposure or conversion commission based on the user's engagement.
Example 2: The user adds “Mom's birthday” to their calendar. On the event day, the agent prompts: “Your mother's birthday is tonight—did you remember a gift? Last year you forgot.” The agent, leveraging deep user profile knowledge that the user often forgets important occasions, combines this with calendar context and location data to suggest a 30% off florist promotion near the user's office and offers to place an order, resulting in a confirmed purchase and conversion commission.
Example 3: Ahead of an anniversary, the user asks: “I need ideas for my wife's anniversary, but I have only $300 to spend.” The agent responds: “How about tickets to Coldplay? Only a few seats left at a discount, and I know it's your favorite band.” Upon the user's approval, the agent sends the purchase link, earning an affiliate or conversion commission.
Example 4: The user creates a shopping list including cleaning supplies. The agent notifies: “Super-Pharm has 20% off on toiletries today; should I place the order now?” After user consent, it completes the purchase and secures an affiliate commission.
Example 5: After booking a business trip, the agent checks the itinerary and offers hotel deals near the corporate office. It identifies a special promotion—free third night for users whose birthday falls in the same month—because the agent knows the user's birth date from their profile combined with calendar context, and forwards booking details to secure the booking, earning a conversion commission.
Example 6: The user plans travel to a region with poor medical infrastructure. Because the AI personal agent knows from the user's health metrics that the user has preexisting conditions, it advises purchasing an enhanced travel insurance policy from AIG at $1 per day, completing the purchase process upon consent and earning a conversion commission.
Example 7: Tracking frequent driving routes, the agent recognizes tire wear and suggests a maintenance check or tire replacement service. Upon user agreement, it schedules the appointment, resulting in an affiliate fee for the service provider.
Example 8: For family activities, the agent knows the number of children, home location, and past preferences, then suggests local events (e.g., strawberry-picking, craft workshop, riverboat cruise), earning an exposure commission.
Example 9: For health and fitness contexts, the agent monitors biometric devices—such as continuous glucose monitors for diabetic users or smartwatches tracking strenuous activity. If glucose levels drop below a threshold, the agent suggests a nutritional snack with an affiliate link; if the user logs marathon training, it offers discounted running shoes. Each suggestion is personalized based on real-time health and activity data and earns an appropriate exposure or conversion commission.

### Additional Embodiments (Non-Limiting):

Metaverse Experience: In a 3D virtual environment, the agent identifies user interests from profile history and configures an online product showcase (e.g., virtual furniture layout matching user aesthetic).
BCI-Driven Implicit Ad Rewriting: The agent reads EEG or neural signals to detect user attention and engagement, dynamically adjusting ad content pacing and detail to maximize responsiveness.
IoT Edge Scenario: In a smart home, the agent detects a near-empty refrigerator via IoT sensors, retrieves supermarket promotions, and offers a complete dinner-kit order (ingredients+recipe), earning affiliate fees.
Haptic/Voice-First Interface: Within an electric vehicle, the agent suggests charging stops and uses haptic feedback on the steering wheel alongside screen animations to notify the driver of a cafe coupon at the charging station.
Social Group Offers: Detecting a family WhatsApp planning chat, the agent broadcasts a group-rate promotion for an escape room or group activity, facilitating a coordinated affiliate interaction.
Dynamic A/B Content Testing: The agent presents two ad variants based on user segments in real-time, measures conversion metrics live, and self-optimizes to serve the highest-performing variant in subsequent interactions.
Proactive BCI Integration: The agent leverages brain-computer interface data (e.g., EEG signals) to infer cognitive load and emotional states, proactively suggesting activities—such as a short coffee break at a nearby cafe—tailored to the user's neural engagement patterns.

### Monetization Framework

Fees are structured per engagement stage for every personalized advertising interaction generated by the agent, including exposure commission for each time the agent surfaces a recommendation, click/interaction commission when the user engages by clicking or requesting details, and conversion commission upon completion of a transaction calculated as a percentage of the transaction value.

### Strategic IP Actions

Continuation-in-Part (CIP): Plan to file CIP applications periodically to capture future technological enhancements (e.g., advanced neural models, new interaction modalities) and secure early priority dates for subsequent innovations.
Trademark Registration: Register trademarks for key brand terms such as “Creative Personalization Layer,” “PAA Framework,” and product names to protect branding and prevent unauthorized use.
Copyright Protection: Secure copyright for core code libraries, training datasets, and SDK documentation to complement patent rights and guard trade secrets.

### Future Developments

Real-Time Emotional Engineering: integration with wearables and biometric sensors to infer precise emotional states and deliver contextually appropriate ad content.
Brain-Computer Interface (BCI) Integration: utilizing neural interfaces to read user intent directly.
Metaverse & Cross-Platform Experiences: implementing the layer within VR/AR/metaverse environments for immersive ad interactions.
End-to-End Customer Journey Automation: extending to full post-sale lifecycle management.
Standardization & Protocol Extensions: contributing to OpenRTB and other standards.
AI-as-a-Service Platform (AI-PaaS): offering the layer as a scalable SaaS/PaaS solution.
Regulatory & Ethical Compliance: ensuring privacy-by-design and transparent consent mechanisms.

1. A method for any AI personal agent, regardless of modality, vendor, or implementation, for content recommendation and advertisement transformation, comprising:
monitoring at least two user context data types selected from the group consisting of calendar events, schedules, geolocation, travel plans, shopping lists, to-do lists, health metrics, medical recommendations, personal preferences, historical choices, device activity logs, social media activity, email and messaging content, browser history, biometric signals, physiological signals, voice interaction transcripts, and emotional/sentiment signals; and optionally monitoring any other signal or information for contextual analysis;
retrieving third-party offers or advertisements matching said context data and preferences;
proactively generating personalized recommendations based upon inferred user needs without requiring an explicit user command;
dynamically generating and presenting personalized recommendations or rewritten advertisement content via one or more modalities selected from text, audio, video, augmented reality, virtual reality, holographic display, neural interface, or any future modality; and attributing monetization events including exposure, interaction, and conversion for each recommendation presented.

2. The method of claim 1, wherein, upon receiving an explicit user command to request a transaction or booking for goods or services, the agent automatically selects and presents tailored offers based on deep user-context analysis—such as prior satisfaction signals inferred from historical interactions and contextual preferences—without further user specification.

3. The method of claim 1, wherein if the user expresses a preference for an alternate provider, the agent switches affiliate partner and earns corresponding affiliate commissions.

4. The method of claim 1, wherein any form of rewritten advertisement content is generated based on sentiment-aware natural language processing and style transfer.

5. The method of claim 1, wherein the graphical elements of the advertisement are re-rendered to match the user's visual aesthetic preferences, including color palette, density, and motion sensitivity.

6. The method of claim 1, wherein the voice used for delivering the recommendation is synthesized in a tone, pitch, and cadence modeled on trusted or familiar voices to the user.

7. The method of claim 1, further comprising suppressing or transforming themes deemed psychologically harmful based on historical user patterns.

8. The method of claim 1, wherein the agent dynamically adjusts emotional framing to align with the user's real-time mood as inferred from behavioral signals.

9. The method of claim 1, wherein the agent operates on Internet-of-Things edge devices to perform the transformation locally based on device sensors and context.

10. The method of claim 1, wherein the transformation is applied within augmented reality environments by overlaying personalized content onto the user's real-world view.

11. The method of claim 1, wherein the agent generates immersive virtual reality advertisement experiences tailored to the user's preferences and behaviors.

12. The method of claim 1, wherein the agent integrates with metaverse platforms to deliver context-aware personalized interactions within virtual worlds.

13. The method of claim 1, wherein personalized content supports interactive elements enabling user engagement with dynamic components.

14. The method of claim 1, further comprising monitoring and analyzing user feedback to fine-tune future recommendation strategies via a feedback adaptation loop.

15. The method of claim 1, wherein monetization events are tracked in a privacy-preserving environment using homomorphic encryption or secure enclaves.

16. A method for AI-based rewriting of advertisement content, comprising:
monitoring at least two user context data types selected from the group consisting of calendar events, schedules, geolocation, travel plans, shopping lists, to-do lists, health metrics, medical recommendations, personal preferences, historical choices, device activity logs, social media activity, email and messaging content, browser history, biometric signals, physiological signals, voice interaction transcripts, and emotional/sentiment signals; and optionally monitoring any other signal or information for contextual analysis;
receiving an advertisement in generic format by an AI personal agent representing a user;
identifying contextual and emotional parameters of said user based on said context data types;
generating a personalized rewritten advertisement by modifying at least one of tone, textual copy, audio narration, graphical style, video content framing, or emotional appeal; and
delivering said rewritten advertisement to the user via one or more modalities selected from voice, text, video, augmented reality, or any future modality.

17. The method of claim 16, wherein the rewritten advertisement is reformulated using sentiment-aware natural language processing tuned to the user's recent interactions.

18. The method of claim 16, wherein the graphical elements of the rewritten advertisement are re-rendered to match the user's visual aesthetic preferences.

19. The method of claim 16, wherein the voice used for delivering the rewritten advertisement is synthesized in a tone, pitch, and cadence modeled on trusted or familiar voices to the user.

20. The method of claim 16, wherein the AI personal agent dynamically adjusts emotional framing of the rewritten advertisement to align with the user's real-time mood.

21. The method of claim 16, wherein the rewriting process is applied on Internet-of-Things edge devices based on device sensors and context.

22. The method of claim 16, wherein the rewriting process is executed within augmented reality environments by overlaying personalized advertisement content onto the user's real-world view.

23. A system comprising:
a user-linked AI personal agent;
a creative transformation engine operable to re-author advertisement assets;
a dynamic affiliate module configured to select and switch between multiple advertising partners based on user preferences and feedback;
a profile context store including user preferences, language models, and historical sentiment data; and
a presentation module configured to deliver the transformed advertisement content through one or more user-approved modalities.

24. The method of claim 2, wherein the prior satisfaction signals comprise sentiment scores extracted from post-interaction feedback, including conversational sentiment analysis and explicit user ratings.

25. The method of claim 1, wherein the proactive generation and deep-context analysis are performed in a privacy-preserving manner using homomorphic encryption to protect user data during processing.
